(19) United States
(12) Patent Application Publication
(10) Pub. No.: US 2008/0155603 A1
(43) Pub. Date: Jun. 26, 2008

(54) SYSTEM AND METHOD FOR INTERACTIVE TARGETED VIDEO CONTENT DELIVERY

(76) Inventor: John THEOBALD, Huntington, NY (US)

Correspondence Address: HOGAN & HARTSON LLP;IP GROUP, COLUMBIA SQUARE, 555 THIRTEENTH STREET, N.W., WASHINGTON, DC, 20004, US

(21) Appl. No.: 11/950,935

(22) Filed: Dec. 5, 2007

Related U.S. Application Data
(60) Provisional application No. 60/872,779, filed on Dec. 5, 2006.

(51) Int. Cl. G06F 3/00

(52) U.S. Cl. 725/46

(57) ABSTRACT

The invention provides a system for delivering targeted video content across a broadcast network. The invention allows content providers to deliver content to groups of consumers with common interests or specified individual subscribers. The invention also allows for the receipt of feedback from viewers. Embodiments of the invention include mechanisms for the subscriber to provide feedback regarding the content and for the subscriber to receive a benefit for providing such feedback.

### CROSS REFERENCE TO RELATED APPLICATIONS

This application claims the benefit of priority of U.S. provisional patent application No. 60/872,779, filed Dec. 5, 2006.

### BACKGROUND OF THE INVENTION

1. Field of the Invention

The invention relates, in general, to the use of a video content delivery system for targeted interactive broadcasts. In particular, the invention relates to identifying individuals to receive targeted broadcasts and delivering content tailored to those individuals for marketing purposes. One further embodiment includes using such a system to market to physicians by delivering medical video content tailored by medical specialty, area of interest, or individual physician.

2. Relevant Background

Managing relationships with customers is a challenge for any business. In the past, salespeople might know all of their customers individually and develop relationships over time. As competition in many industries has increased, potential customers can be overwhelmed by the sheer number of possible choices, and hence develop relationships with no salespeople. In addition, many companies simply have too many customers to cost-effectively maintain the sales force that would be required to give personal attention.

Television and radio offer more cost-effective ways to reach millions of potential customers. However, television and radio advertising are passive customer experiences, so that an individual's specific concerns and interests may not be addressed. Moreover, broadcast advertisements are delivered during another program, meaning that all of the viewers of a given program see all of the advertisements delivered with it, whether or not the viewers have any interest in the advertisement. As a result, advertisers must guess at a program's audience and target some group believed to be in that audience. Although the broadcast industry provides demographic information on its viewers, targeting is hit or miss. Further, more specialized customer bases are simply unreachable through standard broadcast media. For example, while pharmaceutical companies are able to deliver more general product advertising to potential consumers, they cannot use standard commercial advertising to reach physicians, because the specialized information that physicians want would be of absolutely no interest to non-physicians, and there is simply no way to guarantee that a sufficient number of physicians will be watching a given program.

Some companies have turned to the Internet for more individualized marketing. They create websites for interacting with their customers, and in some cases those websites tailor the experience to the customer's profile. The website might present information on topics known to be of interest to the customer, where that information is also related to the company's products and marketing strategy. The idea is that a company can provide useful, detailed information to a consumer or distributor, which attracts the customer to the website, in exchange for the opportunity to focus its presentations on aspects of its products in order to market more effectively to an individual who is known to be interested in those products. Despite this flexibility, television is simply a more effective communicator, and for many people the Internet is still difficult to use effectively.

What is needed is a way to combine the effective communication medium of television with the ability to market products in a flexible and adaptive way to individual, specialized consumers.

### SUMMARY OF THE INVENTION

The invention provides a system for delivering targeted video content across a broadcast network. The invention allows content providers to deliver content to groups of consumers with common interests or specified individual subscribers. The broadcast network may be a computer network, a satellite television broadcasting system, TiVo®, or some other video content delivery system.

The invention enables a content provider to provide content along with characteristics of desired viewers. The invention includes a mechanism for identifying those desired viewers from a database of subscribers. The invention further includes a mechanism for delivering said content to said identified viewers. The invention further includes a mechanism for receiving feedback from viewers. In one embodiment such feedback is a certification that the viewer has watched the entire content. In another embodiment, the feedback is a set of questions which must be answered in order to demonstrate that the viewer has watched the content. In that embodiment, the viewer might receive some form of educational credit, such as CME, CLE, or other professional continuing education credit.

A first aspect of the present invention relates to a method for delivering targeted video content. The method includes identifying target subscribers, distributing tailored video content to target subscribers, and updating subscriber profiles. One embodiment of the method includes collecting feedback from subscribers.

Another aspect of the present invention relates to a system for delivering targeted video content. The system includes a subscriber database, which contains potential video content recipients, and a content database, which contains tailored video content. The system also includes a network for distributing said video content and the same or a separate network for updating said subscriber database. Another component of the system is subscriber equipment for receiving said video content. Embodiments of the invention include mechanisms for the subscriber to provide feedback regarding the content and/or for the subscriber equipment to update the subscriber database based on the subscriber's viewing choices.

### BRIEF DESCRIPTION OF THE FIGURES

The accompanying drawings, which are included to provide a further understanding of the invention and are incorporated in and constitute a part of this specification, illustrate some embodiments of the invention, and together with the description serve to explain the principles of the invention. In the drawings:

FIG. 1 illustrates the high level components of the invention;

FIG. 2 illustrates the method of using the invention.

FIGS. 3A and 3B illustrate embodiments of the invention for distributing content.

### DETAILED DESCRIPTION OF THE PREFERRED EMBODIMENTS

Reference will now be made in detail to the preferred embodiments of the invention. This invention may, however, be embodied in many different forms and should not be construed as limited to the embodiments set forth herein. In addition, and as will be appreciated by one of skill in the art, the invention may be embodied as a method, system, or process.

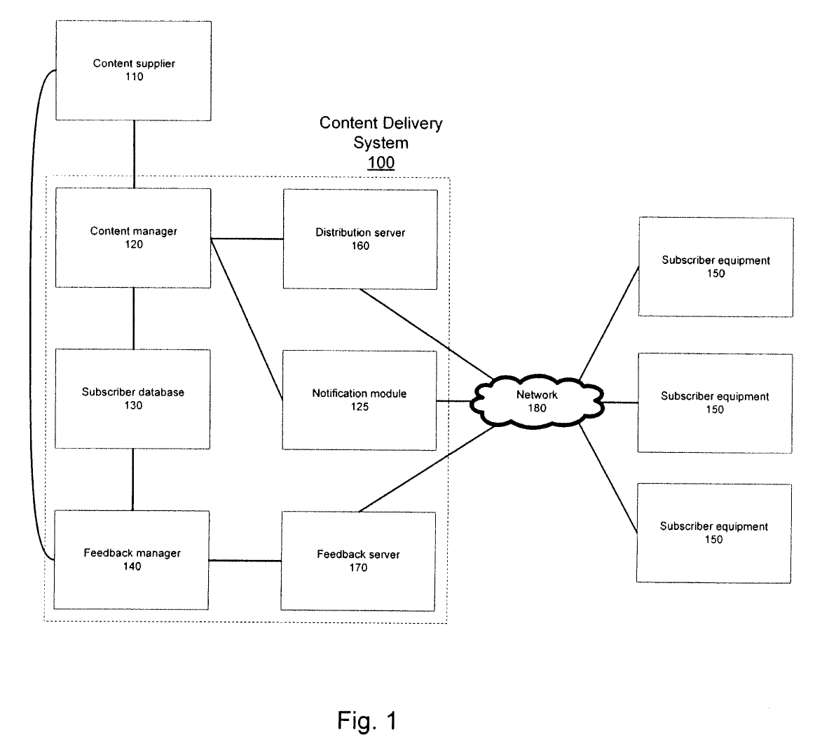

FIG. 1 illustrates a content delivery system for targeted content delivery to an identified set of subscribers in accordance with an embodiment of the invention. In FIG. 1, the content delivery system 100 includes a content manager 120, a subscriber database 130, a notification module 125, a feedback manager 140, a distribution server 160, and a feedback server 170. The content manager 120 receives content from a content supplier 110. The distribution server 160 and the feedback server 170 are connected to a plurality of subscriber equipment 150 through a network 180. The subscriber equipment 150 enables a subscriber to receiver and view content, and also enables a subscriber to provide feedback.

In operation, the system 100 is connected to a plurality of content suppliers 110. A content supplier 110 creates at least one unit of viewable content and a set of desired viewer characteristics. As explained in detail below, this content and characteristics data is processed by the content manager 120. The content manager 120 queries the subscriber database 130 to identify subscribers with the desired characteristics. The content manager 120 uses the notification module 125, which notifies subscriber equipment 150 of available content. The content manager also loads content onto the distribution server 160, which distributes content to subscriber equipment 150. A content supplier 110 also creates feedback, which flows to the feedback manager 140. As explained in detail below, the feedback manager 140 loads the feedback onto the feedback server 170. The feedback manager 140 also updates the subscriber database 130 as subscribers provide feedback to the system 100. Lastly, the feedback manager 140 notifies the content supplier 110 when a subscriber provides feedback so that the content supplier 110 may take appropriate action.

In this way, it can be seen that subscribers may be identified to receive content. Specifically, The profile of a subscriber very much determines if they are a candidate to receive specific programs. This 1-to-1 matching of profile against program content maximizes the potential to engage a subscriber to view a specific program. For example, a doctor can be matched by specialty or history of attending certain conference. Each subscriber device has a unique serial number hence when building a program participation list the respective serial number is extracted to create a unique program distribution list.

While subscribers do not choose which content they receive from a list or is content pushed out, they are made aware of specific programs via a program guide that is sent or by looking a the list of programs that have been downloaded to them. The program guide is created for each program, and the subscriber, whose profile matches the characteristics of the program, receives a copy of the guide. Typically, only relevant subscribers receive the program guide.

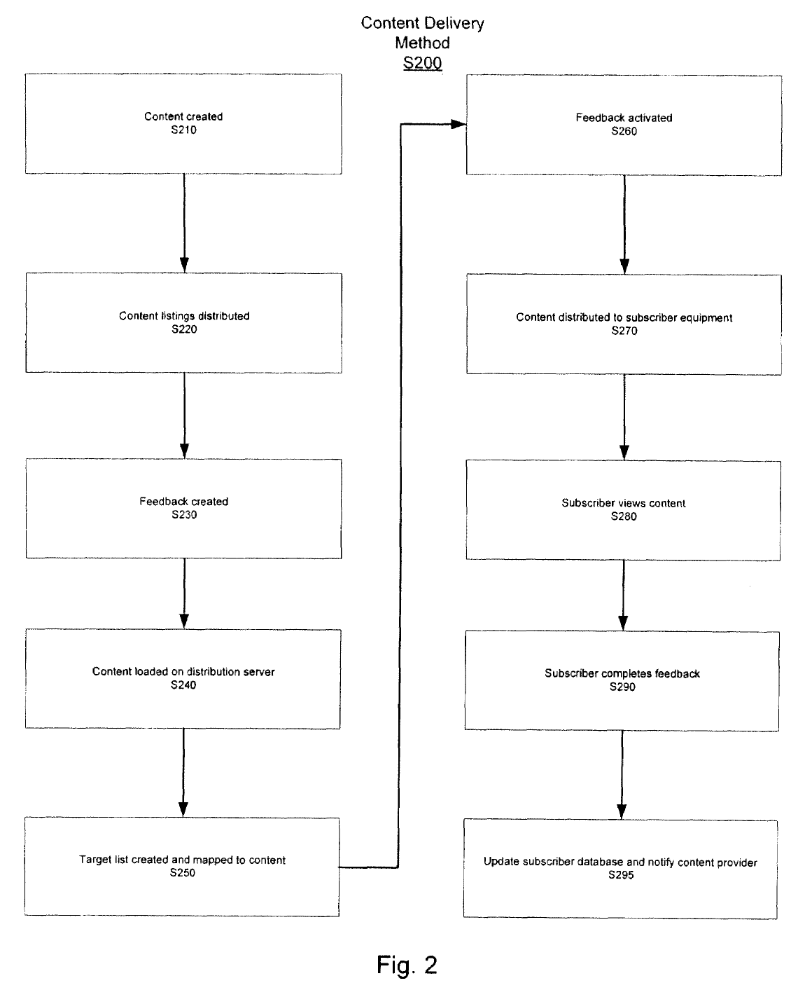

FIG. 2 illustrates the method for targeted video content delivery. The process begins in step S210, where video content is created. In step S220, a listing is created of all of the video content created in step S210. In step S230, a feedback form is created that will later be used by the subscriber after viewing content, as described below. Content is loaded onto a distribution server in step S240. In step S250, a target list is created. The target list identifies, for each unit of content, which subscribers should receive it. When the content is ready for distribution, the feedback is activated in step S260. Activating the feedback means that subscribers can now verify viewing the content. Content is distributed to subscriber equipment in step S270. Subscribers view the content in step S280. Note that there is no requirement for step S280 to occur immediately following step S270. Once the content has been distributed to a subscriber's equipment, the subscriber may view it whenever he pleases, or not at all. If a subscriber never views the content, the rest of the steps are ignored with respect to that subscriber. Once a subscriber views content, he completes the feedback in step S290. In one embodiment, subscribers receive some benefit from completing the feedback, such as educational credit, or credits towards rewards. In step S295, the subscriber database is updated to reflect that a subscriber has completed the feedback for a unit of content, and the original content provider for that content is notified of the subscriber's completion.

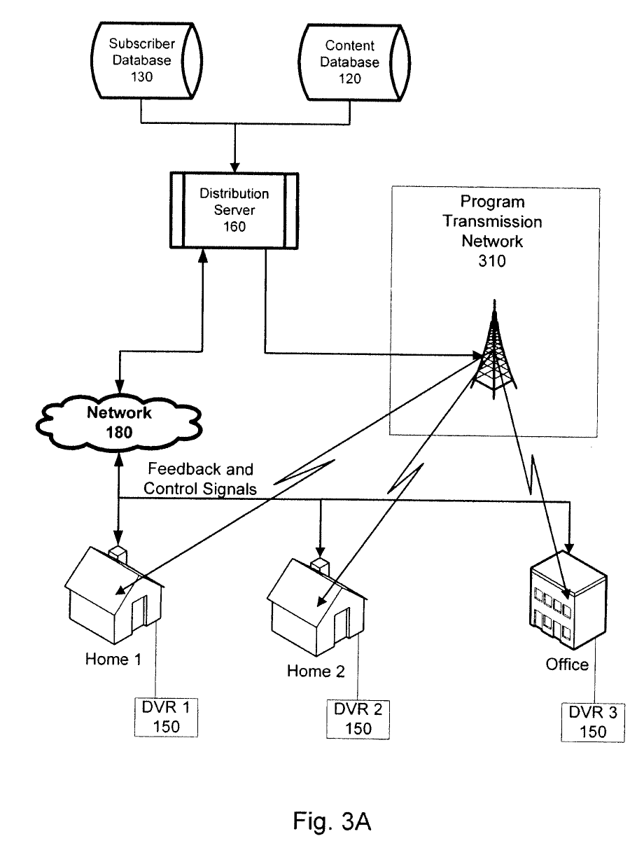

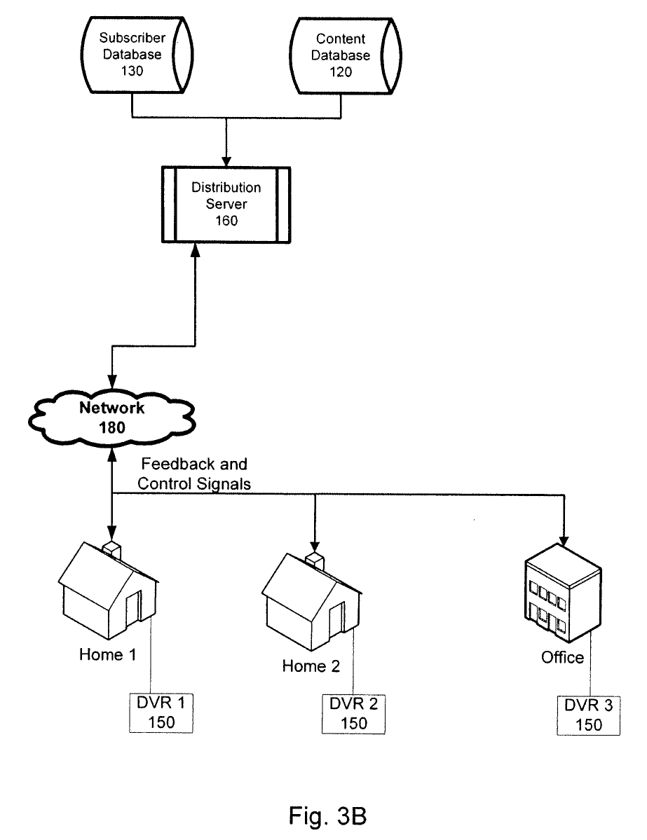

FIG. 3A illustrates one embodiment of the system for distribution of content. In FIG. 3A, a subscriber uses a digital video recorder 150 (DVR) to record content for later viewing. A DVR 150 includes devices that are dedicated to recording video programs, such as a TiVo®, as well as multi-purpose devices, such as multimedia personal computers, that are capable of recording video programs as one feature. In the illustrated embodiment, a DVR 150 sends control messages at regular intervals (e.g., daily) to the distribution server 160. The DVR 150 identifies itself to the distribution server 160 and requests a list of programs to record. The distribution server 160 queries the subscriber database 130 to determine the subscriber associated with the particular DVR 150. Then, the distribution server 160 queries the content database 120 for the program information for all content that should be distributed to the subscriber, and this program information is transmitted back to the DVR 150. For each program, at the time and on the channel indicated in the program information, the distribution server 160 broadcasts the program over the program transmission network 310. The program transmission network may be a satellite network, cable television network, or other system for broadcasting video content. Simultaneously with the broadcast, the DVR 150 begins to record the program in accordance with the earlier retrieved program information.

FIG. 3B illustrates another embodiment of the system for distribution of content. As above, a subscriber uses a DVR 150 to record content. In FIG. 3B, each DVR 150 is independently addressable by the distribution server 160, and each DVR 150 has a known address in the network 180. For example, on an Ethernet network this could be either a fixed IP address or a dynamically updated IP address. As content becomes available from the content database 120, the distribution server 160 transmits that content to the DVR 150 of every subscriber identified to receive that content. When the content arrives, the DVR 150 automatically stores it for later viewing.

Having described preferred embodiments of the invention it will now become apparent to those of ordinary skill in the art that other embodiments incorporating these concepts may be used. Accordingly, it is submitted that the invention should not be limited to the described embodiments but rather should be limited only by the spirit and scope of the appended claims. Although the invention has been described and illustrated with a certain degree of particularity, it is understood that the present disclosure has been made only by way of example, and that numerous changes in the combination and arrangement of steps or orientation of components can be resorted to by those skilled in the art without departing from the spirit and scope of the invention, as hereinafter claimed.

I claim:

1. A method for delivering targeted video content, comprising the steps of:
Identifying target subscribers;
Distributing tailored video content to target subscribers; and
Updating subscriber profiles.

2. The method according to claim 1, wherein subscriber has the option not to view said content.

3. The method according to claim 1, wherein subscriber has the option to view said content on demand.

4. The method according to claim 1, wherein said subscriber submits feedback regarding said content.

5. The method according to claim 4, wherein said subscriber receives a benefit for submitting feedback.

6. The method according to claim 5, wherein said benefit is education credit.

7. A system for delivering targeted video content, comprising:
A subscriber database, including potential video content recipients;
A content database, including tailored video content;
A network for distributing said video content;
A network for updating said subscriber database; and
Subscriber equipment for receiving said video content.

8. The system of claim 7, wherein said subscriber equipment provides said content on demand.

9. The system of claim 7, wherein said subscriber equipment provides feedback regarding subscriber choices.

10. The system of claim 7, wherein said subscriber equipment allows subscriber to submit feedback regarding said content.
